(19) United States
(12) Patent Application Publication
(10) Pub. No.: US 2023/0094418 A1
(43) Pub. Date: Mar. 30, 2023

(54) SELF-TEST LEAKAGE PROTECTOR WITH TIMING FUNCTION AND ELECTRIC EQUIPMENT

(71) Applicant: ZHEJIANG ZHONGXUN ELECTRONICS CO., LTD., Yueqing City (CN)

(72) Inventors: Jianzhong ZHENG, Wenzhou (CN); Guohong LUO, Wenzhou (CN)

(21) Appl. No.: 17/439,191

(22) PCT Filed: May 14, 2021
(86) PCT No.: PCT/CN2021/093801

§ 371 Date: Sep. 14, 2021

(30) Foreign Application Priority Data
Nov. 27, 2020 (CN) 202011359837.7

(51) Int. Cl. H02H 7/122

(52) U.S. Cl. CPC H02H 7/1227

(57) ABSTRACT

The present invention discloses a self-test leakage protector with a timing function, comprising a leakage protection module, a timer module, a DC power supply module, and a DC power supply module control switch, wherein the DC power supply module control switch is connected between the DC power supply module and the leakage protection module, or between input AC power and the DC power supply module that supplies power to the leakage protection module, and is in an off state under a standby condition; according to a timing function requirement, the timer sends a signal of turning off or turning on the DC control switch; and when the turning-on signal is sent, the switch is closed, such that the leakage protection module is powered on for power-on reset, followed by a self-test of a leakage function, and if the self-test is passed, power is supplied to a load, and the self-test is carried out every time before power is supplied to the load. In the invention, the timing function of the timer is integrated in the self-test leakage protector capable of self testing, so the leakage protector is a separate product having a timing function with high safety, low standby power consumption and a low cost.

### FIELD

The present invention relates to the technical field of leakage protection, in particular to a self-test leakage protector with a timing function and electric equipment.

### BACKGROUND

Traditional leakage protectors and timers are manufactured and sold separately, and if both functions are required for electrical control, they must be purchased separately and combined together, which increases the cost and control complexity. On the market, there are products that combine the above-mentioned two functions together, which are either integrated in a leak protector/timer or in a terminal product, but such a product is a simple combination of the two products with limited cost reduction, high standby power consumption, and low safety.

### SUMMARY

Therefore, the present invention provides a self-test leakage protector with a timing function and electric equipment leakage protection, to overcome the shortcomings of a high cost, high power consumption and low safety of a leakage protector in the prior art.

An embodiment of the present invention provides a self-test leakage protector with a timing function, including a leakage protection module, a timer module, a DC power supply module, and a DC power supply module control switch, wherein

the DC power supply module is configured to convert AC power to DC power and supply power to the leakage protection module and the timer module;

the DC power supply module control switch is connected between the DC power supply module and the leakage protection module, or between input AC power and the DC power supply module that supplies power to the leakage protection module, and is in an off state under a standby condition; according to a timing function requirement, the timer module sends a signal of turning off or turning on the DC power supply module control switch; and when the timer module sends the signal of turning on the DC power supply module control switch, the DC power supply module control switch is closed, such that the leakage protection module is powered on for power-on reset, followed by a self-test of a leakage function, and if the self-test is passed, power is supplied to a load, and the self-test is carried out every time before power is supplied to the load.

In an embodiment, the leakage protection module and the timer module share the DC power supply module, or the leakage protection module and the timer module are each connected to an independent DC power supply module for power supply thereto.

In an embodiment, the DC power supply module includes a buck circuit, a rectifier circuit, and a filter-stabilizer circuit connected successively, wherein after the buck circuit performs a voltage step-down operation on the AC power, the power is converted by the rectifier circuit to DC power, which is then led to the filter-stabilizer circuit to output smooth DC power.

In an embodiment, the timer module includes a timer circuit and a switch with timing position indication, or includes a timer circuit, a timing selection switch and a display circuit.

In an embodiment, the timer circuit is an MCU or an application-specific timing integrated circuit.

In an embodiment, the self-test leakage protector with a timing function further includes an AC zero-crossing detection circuit, which is connected between the DC power supply module and the timer module to provide time base correction for the MCU in the timer module.

In an embodiment, the switch with timing position indication is a rotary switch including a plurality of timing positions to indicate timing lengths to be selected.

In an embodiment, the display circuit comprises a plurality of indicator lights to indicate timing lengths.

In a second aspect, an embodiment of the present invention provides electric equipment, including the self-test leakage protector with a timing function in the first aspect integrated on a device thereof.

The technical solutions of the present invention have the following advantages:

1. The self-test leakage protector with a timing function provided in an embodiment of the present invention includes a leakage protection module, a timer module, a DC power supply module, and a DC power supply module control switch, wherein the DC power supply module control switch is connected between the DC power supply module and the leakage protection module, or between input AC power and the DC power supply module that supplies power to the leakage protection module, and is in an off state under a standby condition; according to a timing function requirement, the timer module sends a signal of turning off or turning on the DC power supply module control switch; and when the timer module sends the signal of turning on the DC power supply module control switch, the DC power supply module control switch is closed, such that the leakage protection module is powered on for power-on reset, followed by a self-test of a leakage function, and if the self-test is passed, power is supplied to a load, and the self-test is carried out every time before power is supplied to the load. In the invention, the timing function of the timer is integrated in the self-test leakage protector capable of self testing, so the leakage protector is a separate product having a timing function with high safety, low standby power consumption and a low cost.

2. The timer switch of the self-test leakage protector with a timing function provided in an embodiment of the present invention is a selector switch with time scale, so a time indication circuit can be omitted to reduce the cost, while reducing the standby power consumption of the timer module.

3. In the electric equipment provided in an embodiment of the present invention, a self-test leakage protector with a timing function is integrated thereon, and when a timing signal controls the leakage protection module to be connected to the supply power, the leakage protection module has a function of power-on reset, and a self-test of a leakage function is carried out immediately after the power-on reset, to ensure electric equipment and personal safety.

### BRIEF DESCRIPTION OF THE DRAWINGS

To describe the technical solutions in the embodiments of the present invention or in the prior art more clearly, the accompanying drawings to be used in the description of the embodiments or the prior art are introduced below briefly. Obviously, the accompanying drawings in the following description are merely some of the embodiments of the present invention, and for those of ordinary skill in the art, other drawings may also be obtained based on these drawings without creative work.

FIG. 1 is a modular composition diagram of an example of a leakage protector with a self-test function provided in an embodiment of the present invention;

FIG. 2 is a modular composition diagram of another example of a leakage protector with a self-test function provided in an embodiment of the present invention;

FIG. 3 is a circuit diagram of a specific example of a leakage protector with a self-test function provided in an embodiment of the present invention;

FIG. 4 is a schematic circuit diagram of a timer module part of the leakage protector with a self-test function in FIG. 3;

FIG. 5 is a circuit diagram of another specific example of a leakage protector with a self-test function provided in an embodiment of the present invention; and

FIG. 6 is a schematic circuit diagram of the leakage protector with a self-test function provided in FIG. 5.

### DETAILED DESCRIPTION OF THE EMBODIMENTS

Technical solutions of the present invention will be described below clearly and completely in conjunction with the accompanying drawings. Obviously, the described embodiments are part of, instead of all of embodiments of the present invention. All other embodiments obtained by those of ordinary skill in the art without creative work, based on the embodiments in the present invention, fall into the protection scope of the present invention.

In addition, technical features involved in different embodiments of the present invention described below may be combined with each other so long as they do not conflict with each other.

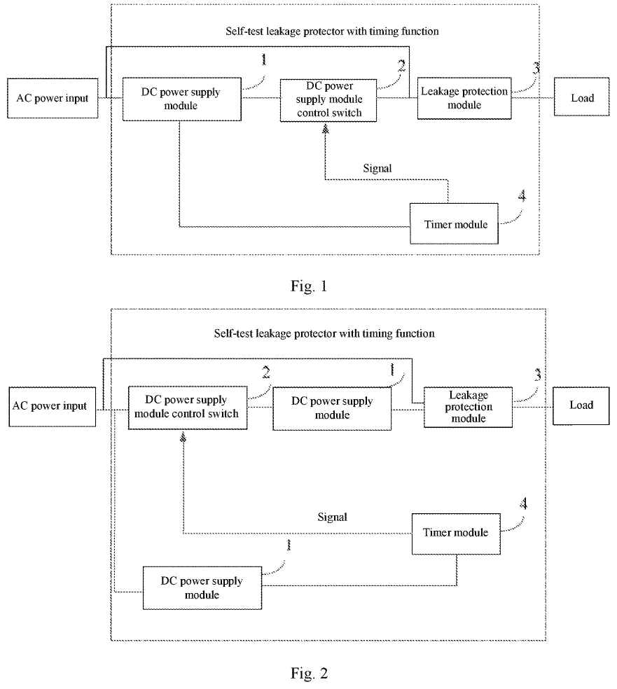

A self-test leakage protector with a timing function provided in an embodiment of the present invention includes a DC power supply module 1, a DC power supply module control switch 2, a leakage protection module 3, and a timer module 4, wherein the DC power supply module 1 is configured to convert AC power to DC power and supply power to the leakage protection module 3 and the timer module 4; the leakage protection module 3 and the timer module 4 share the DC power supply module (as shown in FIG. 1), or the leakage protection module and the timer module are each connected to an independent DC power supply module for power supply thereto (as shown in FIG. 2); in the case where the leakage protection module 3 and the timer module 4 share the DC power supply module, the DC power supply module control switch 2 is connected between the DC power supply module and the leakage protection module (as shown in FIG. 1); in the case where the leakage protection module and the timer module are each connected to an independent DC power supply module for power supply thereto, the DC power supply module control switch 2 is connected between input AC power and the DC power supply module that supplies power to the leakage protection module (as shown in FIG. 2); under a standby condition, the DC power supply module control switch 2 is in an off state; according to a timing function requirement, the timer module 4 sends a signal of turning off or turning on the DC power supply module control switch 2; and when the timer module 4 sends the signal of turning on the DC power supply module control switch, the DC power supply module control switch 2 is closed, such that the leakage protection module 3 is powered on for power-on reset, followed by a self-test of a leakage function, and if the self-test is passed, power is supplied to a load, and the self-test is carried out every time before power is supplied to the load.

The DC power supply module 1 in this embodiment includes a buck circuit, a rectifier circuit, and a filter-stabilizer circuit connected successively, wherein after the buck circuit performs a voltage step-down operation on the AC power, the power is converted by the rectifier circuit to DC power, which is then led to the filter-stabilizer circuit to output smooth DC power.

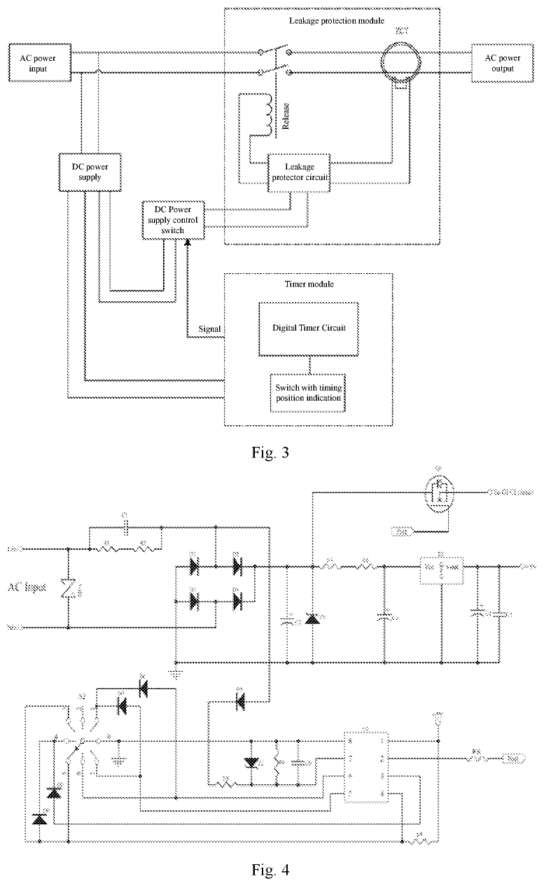

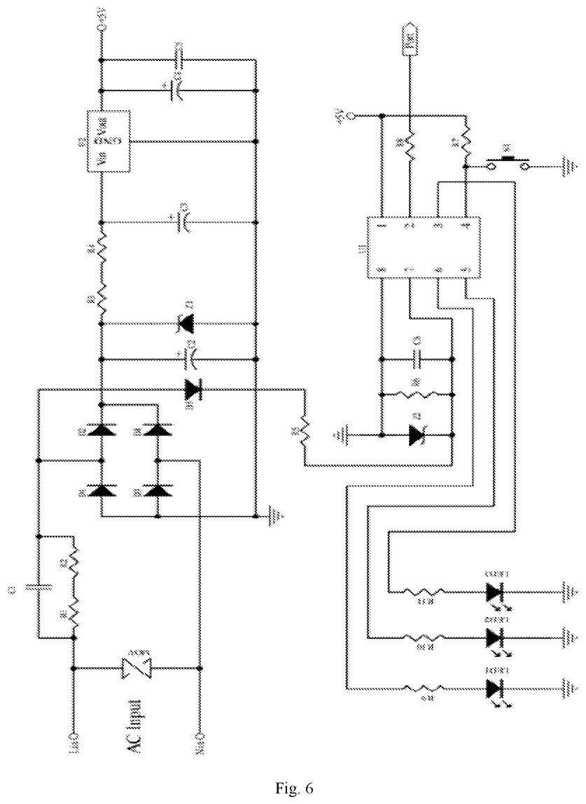

The timer module in this embodiment includes a timer circuit and a switch with timing position indication (as shown in FIG. 3), or includes a timer circuit, a timing selection switch and a display circuit (as shown in FIG. 5), wherein the timer circuit is an MCU or an application-specific timing integrated circuit. The switch with timing position indication is a rotary switch including a plurality of timing positions to indicate timing lengths to be selected. The leakage protector in this embodiment further includes an AC zero-crossing detection circuit, which is connected between the DC power supply module and the timer module to provide time base correction for the MCU in the timer module.

In a specific embodiment, as shown in FIG. 3, the leakage protector is located between an AC power input and an AC power output, wherein the leakage protection module includes a release, a transformer ZCT and a leakage protection circuit; the timer module includes a timer circuit and a switch with position indication; the timer module and the leakage protection module share a DC power supply source (DC power supply), and the timer module controls the on/off of the direct-current power supply module control switch (DC power supply control switch) by sending a signal, thereby controlling the operation of the leakage protector, and supplying power to a load (AC power output) after leakage detection.

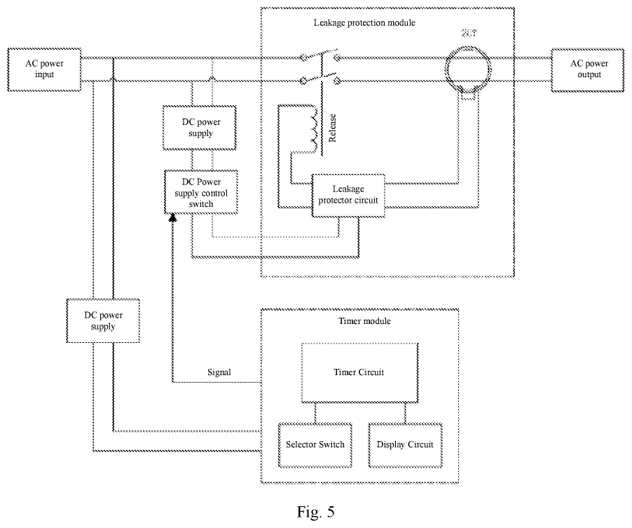

FIG. 4 shows a schematic circuit diagram of a corresponding timer module part of the leakage protector in FIG. 3. The leakage protector module GFCI in this embodiment can achieve a self-test function, and its specific circuit is a leakage protection circuit that can achieve a self-test in the prior art, such as a circuit structure of patent CN211629848U, which will not be described here. The DC power supply module control switch Q1 may be a relay or a semiconductor device (such as MOSFET, BJT, or SCR). In the DC power supply module, the buck circuit includes a buck capacitor C1, and resistors R1 and R2 which provide a discharge circuit for the capacitor C1; the rectifier circuit is a bridge rectifier circuit composed of D1-D4; and the filter-stabilizer circuit includes a filter capacitor C2, a stabilizer Z1, voltage divider resistors R3 and R4, a secondary filter capacitor C3, U2 which is a voltage stabilizing IC, and a low-frequency filter capacitor C4 and a high-frequency filter capacitor C5 after voltage stabilization. The timer main control circuit U1 is an MCU, in which pin1 is a power pin, Pin8 is grounded, Pin2-7 are all I/O ports; and a diode D5, a resistor R5, a voltage stabilizer Z2, a resistor R6, and a capacitor C6 form an AC zero-crossing detection circuit to provide time base correction for the MCU.

The switch S2 with timing position indication in the embodiment of the invention is a selector switch with time scale, so a time indication circuit can be omitted to reduce the cost, while reducing the standby power consumption of the timer module. A timing length is adjusted by the rotary switch (a first gear position indicates stay-on; a second gear position indicates stop; a third gear position indicates a timing length of 2 hours delayed by 20 minutes; a fourth gear position indicates a timing length of 4 hours delayed by 20 minutes; a fifth gear position indicates a timing length of 6 hours delayed by 20 minutes; a sixth gear position indicates a timing length of 8 hours delayed by 20 minutes; and a seven gear position indicates a timing length of 12 hours delayed by 20 minutes). After a midway gear shift, the timer recounts time; and after 24 hours, the timer is restarted for timing (24 hours is for a cycle period for the timer), and the timing lengths corresponding to the gear positions of the rotary switch described above are only used as an example, but not a limitation.

In another specific embodiment, the leakage protector includes components as shown in FIG. 5, and differs from the leakage protector shown in FIG. 3 in that the timer module includes a timer circuit, a selector switch, and a display circuit; and the leakage protection module and the timer module are each connected to an independent DC power supply module for power supply thereto (DC power supply), and the timer module controls the on/off of the direct-current power supply module control switch (DC power supply control switch) by sending a signal, thereby controlling the operation of the leakage protector.

FIG. 6 shows a schematic circuit diagram of the corresponding leakage protector in FIG. 5, and differs from FIG. 4 in that the timer module selector switch S1 is a press trigger button, and the timer is triggered by pressing the selector switch S1; and the display circuit includes three LED indicator lights (LED1, LED2, and LED3), and a lighted number of an indicator light is used to indicate a timing length, and it may be so set in practical applications that LED1 indicates a timing length of 2 hours when it is solid on, indicates a timing length of 4 hours when it flashes, and indicates completion of timing when it goes off; LED2 indicates a timing length of 6 hours when it is solid on, indicates a timing length of 8 hours when it flashes, and indicates completion of timing when it goes off; LED3 indicates a timing length of 10 hours when it is solid on, indicates a timing length of 12 hours when it flashes, and indicates completion of timing when it goes off; and when all the indicator lights are off, it means that the DC power supply module control switch is off. It is to be noted that the configuration of the display circuit is only used as an example, but not a limitation.

An embodiment of the present invention further provides electric equipment, the self-test leakage protector with a timing function described in the above embodiment being integrated on a device thereof. The electric equipment may be any of electric fittings or various electric equipment that need leakage protection, such as various power tools, swimming pool pumps (SPAs), electric equipment operating in engineering applications, etc. By integrating the leakage protector provided in this embodiment, the equipment is not only low in standby power consumption and low in cost, but also high in safety, and electric equipment and personal safety can be ensured.

Obviously, the embodiments described above are merely examples for clear description, and are not intended to limit the implementations. Other variations or modifications of the various forms may also be made by those skilled in the art based on the above description. There is no need and no way to describe all implementations in an exhaustive manner here. Obvious variations or modifications derived therefrom are still within the protection scope of the invention-creation.

1. A self-test leakage protector with a timing function, comprising a leakage protection module, a timer module, a DC power supply module, and a DC power supply module control switch, wherein
the DC power supply module is configured to convert AC power to DC power and supply power to the leakage protection module and the timer module;
the DC power supply module control switch is connected between the DC power supply module and the leakage protection module, or between input AC power and the DC power supply module that supplies power to the leakage protection module, and is in an off state under a standby condition; according to a timing function requirement, the timer module sends a signal of turning off or turning on the DC power supply module control switch; and when the timer module sends the signal of turning on the DC power supply module control switch, the DC power supply module control switch is closed, such that the leakage protection module is powered on for power-on reset, followed by a self-test of a leakage function, and if the self-test is passed, power is supplied to a load, and the self-test is carried out every time before power is supplied to the load.

2. The self-test leakage protector with a timing function according to claim 1, wherein the leakage protection module and the timer module share the DC power supply module, or the leakage protection module and the timer module are each connected to an independent DC power supply module for power supply thereto.

3. The self-test leakage protector with a timing function according to claim 2, wherein the DC power supply module comprises a buck circuit, a rectifier circuit, and a filter-stabilizer circuit connected successively, wherein after the buck circuit performs a voltage step-down operation on the AC power, the power is converted by the rectifier circuit to DC power, which is then led to the filter-stabilizer circuit to output smooth DC power.

4. The self-test leakage protector with a timing function according to claim 1, wherein the timer module comprises a timer circuit and a switch with timing position indication, or comprises a timer circuit, a timing selection switch and a display circuit.

5. The self-test leakage protector with a timing function according to claim 4, wherein the timer circuit is an MCU or an application-specific timing integrated circuit.

6. The self-test leakage protector with a timing function according to claim 5, further comprising an AC zero-crossing detection circuit, which is connected between the DC power supply module and the timer module to provide time base correction for the MCU in the timer module.

7. The self-test leakage protector with a timing function according to claim 4, wherein the switch with timing position indication is a rotary switch comprising a plurality of timing positions to indicate timing lengths to be selected.

8. The self-test leakage protector with a timing function according to claim 4, wherein the display circuit comprises a plurality of indicator lights to indicate timing lengths.

9. Electric equipment, comprising the self-test leakage protector with a timing function of claim 1 integrated on a device thereof.
